(19) United States
(12) Patent Application Publication
(10) Pub. No.: US 2016/0086280 A1
(43) Pub. Date: Mar. 24, 2016

(54) EVALUATION METHOD, EVALUATION DEVICE, AND PROGRAM

(71) Applicant: DATA SCIENTIST CORP., Tokyo (JP)

(72) Inventors: Yotaro OKIYAMA, Tokyo (JP); Naoya SAKAKIBARA, Tokyo (JP)

(21) Appl. No.: 14/890,338

(22) PCT Filed: May 21, 2014
(86) PCT No.: PCT/JP2014/063489

§ 371 Date: Nov. 10, 2015

(30) Foreign Application Priority Data
Jun. 2, 2013 (JP) 2013-116546

(51) Int. Cl. G06Q 40/06; G06F 17/30

(52) U.S. Cl. CPC G06Q 40/06; G06F 17/30867; G06F 17/3053; G06F 17/30887; G06F 17/30528

(57) ABSTRACT

An investment judgement support server refers a website ranking of a corresponding website for each search term in a search term group ranking list as a ranking reference destination, sums a multiplication result obtained by multiplying a click through rate, which corresponds to the referred ranking of each search term, by a search volume of each search term, and makes a division result of dividing a sum of the multiplication result by a sum of the search volume of each search term a click share rate that is unique to the search term group ranking list as the ranking reference destination in the corresponding website.

### CROSS-REFERENCE TO RELATED APPLICATIONS

This application is a 371 U.S. National Stage application of International Application No. PCT/JP2014/063489, filed on May 21, 2014, which claims priority to Japanese Patent Application No. 2013-116546, filed on Jun. 2, 2013. The entire disclosures of the above applications are incorporated herein by reference.

### TECHNICAL FIELD

The present invention relates to a technology of evaluating a corporate value.

### BACKGROUND TECHNOLOGY

Various technologies of evaluating a corporate value, which is difficult to be estimated based on financial statements, are proposed. For instance, a technology, in which potential ability of each “intellect” is quantified and presented based on financial statements data of each company, is disclosed in Japanese Patent Publication Number 2004-348170. A server disclosed in Japanese Patent Publication Number 2004-348170 calculates standardization data for each company that is obtained by standardizing technical innovation ability, relationships with customers and business partners, employees' productivities, ability to use facilities, a future-profits expectation that is brought by an intellectual activity and a market viewpoint with a mean value and a standard deviation for every industry type that is preliminarily classified. A main component analysis process is performed for this standardization data collectively based on a variance-covariance matrix, and a numerical value that is obtained by adding factors, in which each factor is multiplied by a weighting value, for every company is presented as potential ability of the intellect. The numerical value presented by this technology is served as an index having a high reliability with respect to a corporate value that is produced when a company uses all the potential ability of the intellect. Therefore, a user can make an objective determination about whether a present stock price is relatively cheap or comparatively high-priced by comparing and checking this numerical value with a market capitalization in a stock market.

### Problems to be Solved by the Invention

Some companies depend greatly on a website in regards to sales. In these kinds of companies, how many browsers can be led to their own company websites from various search engine websites influences their profits. Therefore, when a competitive strength of a display order that is accounted for in search results of the search engine websites in these kinds of companies can be quantified well, a highly accurate prediction that relates to the profits of these kinds of companies should be able to be made, but such a system has not been implemented.

The present invention is accomplished in order to solve these problems. An object of the present invention is to provide technical means for obtaining a highly reliable index for measuring the competitive strength of each company that is related to the display order of the search results of the search engine website.

### Means for Solving the Problems

In order to solve the above problems, an evaluation method according to one aspect of the present invention is to provide an evaluation method that sums a number of clicks at a website in a search result of a search engine site with respect to each search term belonging to search term groups which a hypothetical customer of the website uses as a query for the search engine site, that obtains a click share rate that is a division result of dividing a sum of the number of clicks of the search term groups by a sum of a search volume of the search term groups, and that presents the click share rate as an evaluation index value for the website.

In the evaluation method, a number of clicks at the website in the search result of the search engine site with respect to each of the search terms of the search term groups is summed up, the division result of dividing the sum of the number of clicks of the search term groups by the sum of the search volume of the search term groups is defined as the click share rate, and the click share rate is presented as the evaluation index value of for the website. Here, when an internet user buys goods and services via sites in the Internet, there are a tremendous number of cases in which goods and services are ordered in the following manner: accessing a search engine and searching with a search key that is a related term; and finding a best matched site for the user's preference among sites of each company shown as a search result. Considering the above mentioned circumstances, with respect to goods and services that are sold and bought via the Internet, it can be seen that a search volume of related terms for the corresponding goods and services in the search engine and a market size thereof are equivalent. The click share rate according to the present invention is a value that is obtained by a calculation in which a search volume that is equivalent to a market size of goods and services relating to search terms is a denominator and a sum value (presumed inflow) of the number of clicks of each website is a numerator. Therefore, the click share rate of a website that is obtained by the present invention is a value that has an extremely strong positive correlation with a market share of the goods and services of a company that owns the website. Therefore, according to this evaluation method, a user can make a highly accurate prediction related to the profits of a company that depends on services on a website for many of their sales.

An evaluation method according to another aspect of the present invention is an evaluation method of a corporate value by a computer, the computer having a memory device that stores a first database containing URLs of a plurality of websites and a second database containing a plurality of search term groups which a hypothetical customer of the plurality of websites uses as a query for a search engine site, the evaluation method comprising: generating a ranking list by the computer including: transmitting each search term of the plurality of search term groups to the search engine site as the query with respect to each of the plurality of search term groups in the second database; obtaining a search result for each of the search terms as the query from the search engine site; generating a search term group ranking list in which a website ranking of each of the search terms within the same website of the plurality of websites is classified; and storing the generated search term group ranking list in the memory device; and presenting an evaluation result by the computer including: referring the website ranking of a corresponding website for each of the search terms in the search term group ranking list, which is for each of the plurality of search term groups in the memory device, as a ranking reference destination with respect to each of the URLs of the plurality of websites in the first database; summing a multiplication result obtained by multiplying a click through rate, which corresponds to the referred ranking of each of the search terms, by a search volume of each of the search terms; obtaining a click share rate that is a division result of dividing a sum of the multiplication result by a sum of the search volume of each of the plurality of search term groups, the click share rate being unique to the search term group ranking list as the ranking reference destination in the corresponding website; and presenting the click share rate as an evaluation index value for the corresponding website.

In this evaluation method, the computer refers the website ranking of a corresponding website for each of the search terms in the search term group ranking list as a ranking reference destination, sums a multiplication result obtained by multiplying a click through rate, which corresponds to the referred ranking of each of the search terms, by a search volume of each of the search terms, makes a division result of dividing a sum of the multiplication result by a sum of the search volume of each of the plurality of search term groups as a click share rate that is unique to the search term group ranking list as the ranking reference destination in the corresponding website, and presents the click share rate as an evaluation index value for the corresponding website. The click share rate of a website that is obtained by this evaluation method is a value that has an extremely strong positive correlation with a market share of the goods and services of a company that owns the website. Therefore, according to this evaluation method, a user can make a highly accurate prediction related to the profits of a company that depends on services on a website for many of their sales.

Further, an evaluation method according to another aspect of the present invention is an evaluation method of a corporate value by a computer, the computer having a memory device that stores a first database containing URLs of a plurality of websites which an evaluated company holds and a second database containing a plurality of search term groups which a hypothetical customer of the plurality of websites uses as a query for a search engine site, the evaluation method comprising: generating a ranking list by the computer including: transmitting each search term of the plurality of search term groups to the search engine site as the query with respect to each of the plurality of search term groups in the second database; obtaining a search result for each of the search terms as the query from the search engine site; generating a search term group ranking list in which a website ranking of each of the search terms within the same website of the plurality of websites is classified; and storing the search term group ranking list of each of the plurality of search term groups in the memory device; calculating a click share by the computer including: referring the website ranking of a corresponding website for each of the search terms in the search term group ranking list, which is for each of the plurality of search term groups in the memory device, as a ranking reference destination with respect to each of the URLs of the plurality of websites in the first database; summing a multiplication result obtained by multiplying a click through rate, which corresponds to the referred ranking of each of the search terms, by a search volume of each of the search terms; and obtaining a click share rate that is a division result of dividing a sum of the multiplication result by a sum of the search volume of each of the plurality of search term groups, the click share rate being unique to the search term group ranking list as the ranking reference destination in the corresponding website; and presenting an evaluation result by the computer including: generating an index value for an investment judgement, the index value being obtained by adding or weight-adding the click share rate, which is calculated for the search term group ranking list with respect to each of the URLs of the plurality of websites in the first database; and presenting a relationship between the index value and one of a stock price and a financial index value of the company.

In this evaluation method, the computer refers the website ranking of a corresponding website for each of the search terms in the search term group ranking list as a ranking reference destination, sums a multiplication result obtained by multiplying a click through rate, which corresponds to the referred ranking of each of the search terms, by a search volume of each of the search terms, makes a division result of dividing a sum of the multiplication result by a sum of the search volume of each of the plurality of search term groups as a click share rate that is unique to the search term group ranking list as the ranking reference destination in the corresponding website, and generates an index value for an investment judgement. The index value is obtained by adding or weight-adding the click share rate, which is calculated for the search term group ranking list with respect to each of the URLs of the plurality of websites in the first database.

### BRIEF DESCRIPTION OF THE DRAWINGS

FIG. 1 is a diagram that shows an entire configuration of an investment judgement support system that includes an investment judgement support server according to a first embodiment of the present invention.

FIG. 2 is a data structure diagram of a database DB1 in a hard disk of the investment judgement support server explained above.

FIG. 3 is a data structure diagram of a database DB2 in a hard disk of the investment judgement support server explained above.

FIG. 4 is a data structure diagram of a database DB3 in a hard disk of the investment judgement support server explained above.

FIG. 5 is a flow diagram that shows an operation of the investment judgement support server explained above.

FIGS. 6A-6B are diagrams that show a procedure of a list generation process in the investment judgement support server explained above.

FIG. 7 is a diagram that shows a procedure of a list generation process in the investment judgement support server explained above.

FIG. 8 is a diagram that shows a procedure of a click share calculation process in the investment judgement support server explained above.

FIG. 9 is a diagram that shows a procedure of a click share calculation process in the investment judgement support server explained above.

FIG. 10 is a diagram that shows a procedure of an evaluation presentation process in the investment judgement support server explained above.

FIG. 11 is a diagram that shows an entire configuration of an investment judgement support system that includes an investment judgement support server according to a second embodiment of the present invention.

FIGS. 12A-12B are diagrams that show a procedure of a list generation process in the investment judgement support server explained above.

### EMBODIMENTS OF THE PRESENT INVENTION

Embodiments of the present invention are explained below with reference to the drawings.

### First Embodiment

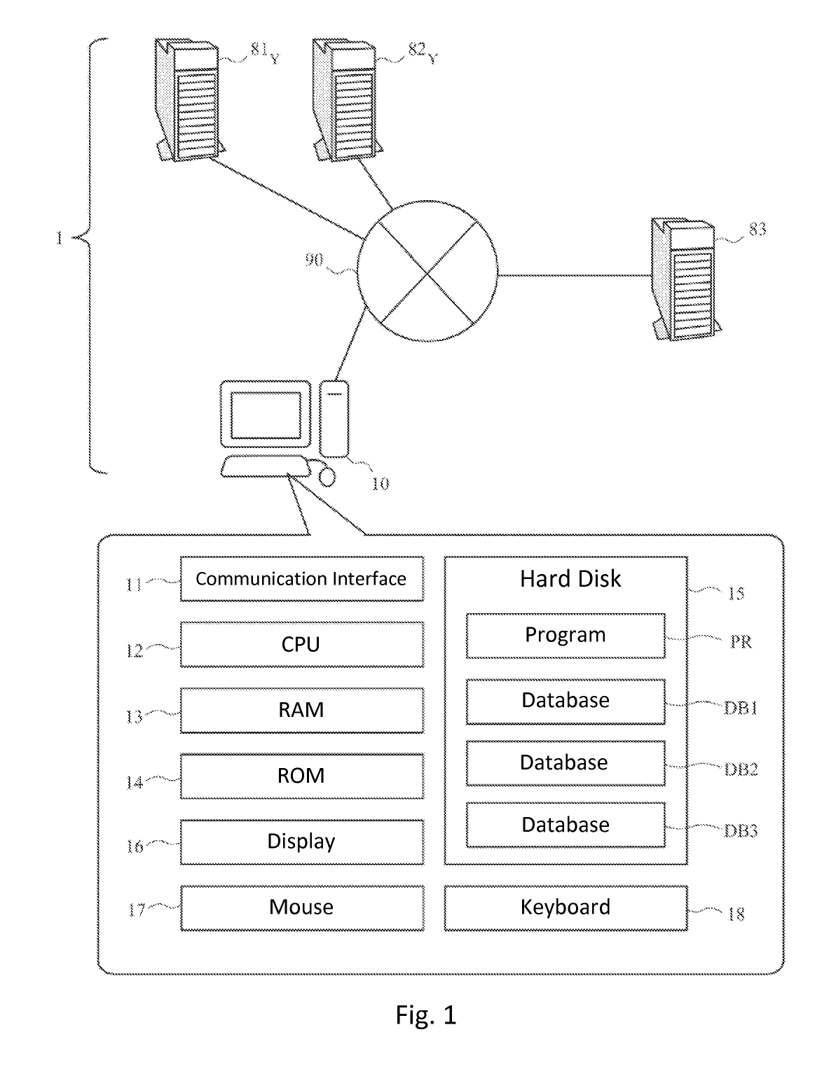

FIG. 1 is a diagram that shows an entire configuration of an investment judgement support system 1 that includes an investment judgement support server (an evaluation device) according to a first embodiment of the present invention. The investment judgement support system 1 makes a company C that performs business activities by using two or more kinds of website advertisements as an evaluation object, and quantitatively evaluates a competitive strength of this company C by using a measure that is referred to as a click share rate CTSₘ.

As shown in FIG. 1, the investment judgement support system 1 is configured with a search engine server 81_{Y} and a keyword advice tool server 82_{Y} that work under management of a managing agency entrepreneur of a search engine site SE_{Y}, a stock price information providing server 83 that works under management of a stock company, and an investment judgement support server 10 that works under management of an entrepreneur who evaluates each company C.

The search engine server 81_{Y} is a device that performs a role of providing a search engine service. The search engine server 81_{Y} receives a query (a request containing a search term) in which an address corresponds to a URL of the search engine site SE_{Y} from a computer connected to the Internet 90, searches related websites that have high relevance with the search term contained in the query out of websites WS in the Internet 90, and provides a search result R in which a set of titles of the searched websites WS, URLs (Uniform Resource Location) and snippets (an extract of the website) are arranged in ascending order.

The keyword advice tool server 82_{Y} is a device that performs a role of providing a keyword advice tool service. The keyword advice tool server 82_{Y} receives a request containing a search term from a computer connected to the Internet 90 and provides a response containing a related term group (specifically, a synonymous term of the search term in the request, a replaceable word and a compound keyword of a combination of the search term in the request and another word relevant to the search term) of the search term in the request and a search volume (a statistic of a total of the query containing the search term per month) of each search term of the related term group in the search engine site SE_{Y}.

The stock price information providing server 83 is a device that performs a role of providing the stock price information of the company C. The stock price information providing server 83 receives a request including a stock code of the company C from a computer connected to the Internet 90 and provides the latest stock price P of a stock of a brand corresponding to a stock code in the request as the stock price information.

The investment judgement support server 10 is a device that performs a role of providing an investment judgement support service. The investment judgement support server 10 is configured with a communication interface 11, a CPU 12, a RAM 13, a ROM 14, a hard disk 15, a display 16, a mouse 17 and a keyboard 18. The communication interface 11 transmits and receives data to and from a device connected to the Internet 90. The CPU 12 executes various programs that are stored in the ROM 14 and the hard disk 15 while using the RAM 13 as a work area. An IPL (Initial Program Loader) and so on are stored in the ROM 14. An evaluation program PR that has a characteristic function peculiar to the present embodiment, and databases DB1, DB2, and DB3 are stored in the hard disk 15.

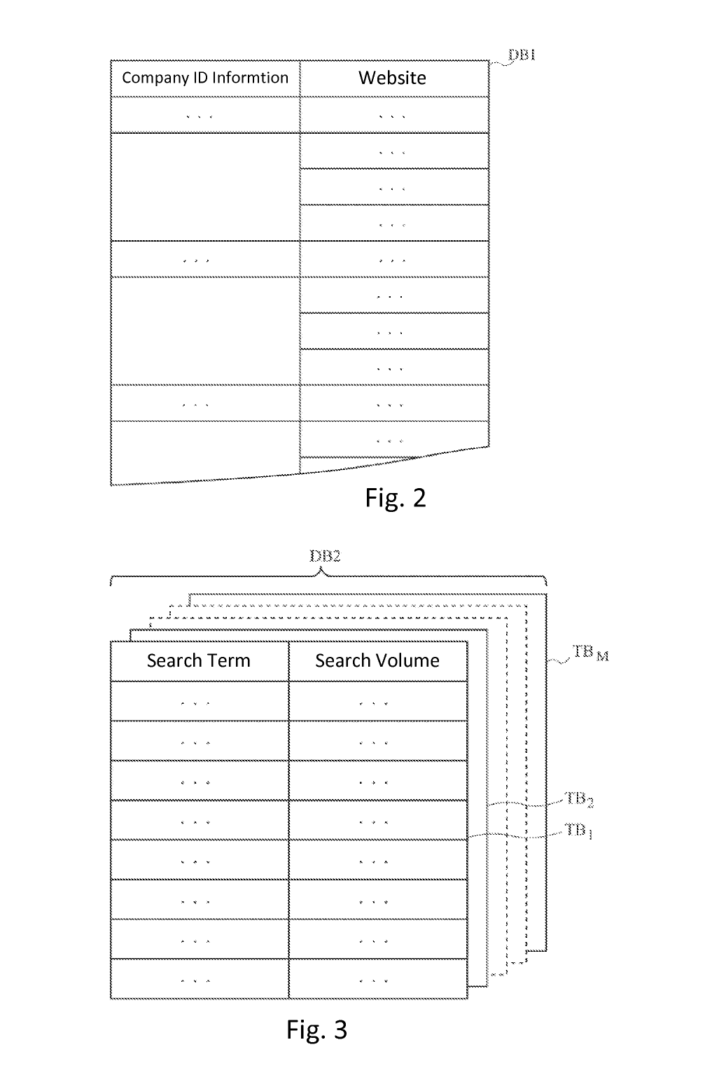

FIG. 2 is a diagram that conceptually shows a data structure of the database DB1. The database DB1 is an aggregate of a plurality of records in which each record corresponds to each company C that is an evaluation object. Each record of the database DB1 has two fields of “company identification information” and a “website.” The field of the “company identification information” shows identification information (for instance, a securities identification code of the company C) of the company C that is the evaluation object. The field of the “website” shows the URLs of two or more websites WS_{C} that are held by the company C that is the evaluation object.

FIG. 3 is a diagram that conceptually shows a data structure of the database DB2. The database DB2 has M tables TBₘ (m=1-M) that correspond to search term groups TGₘ (m=1-M, m corresponds to an index that shows the search term groups and M indicates the total number of the search term groups). Here, the search term groups TGₘ (m=1-M) correspond to the search terms that will be used as a query for the search engine site SE_{Y} by a hypothetical customer of goods or services handled by the website WS_{C} owned by the company C and are classified by relevant goods and services of the same description.

One table TBₘ that corresponds to one search term group TGₘ in the database DB2 is an aggregate of a plurality of records which correspond to a plurality of search terms Tₘ−n (n=1-Nₘ, n is an index that shows a search term, Nₘ is a total number of the search terms that belong to the search term group TGₘ) that belong to the search term group TGₘ. Each record of the table TBₘ has two fields of a “search term” and a “search volume.” The field of the “search term” shows the search terms Tₘ−n that belong to the search term group TGₘ. The field of the “search volume” shows a search volume SVₘ−n (a statistic value of the total number (a reception total of the query that includes the search term Tₘ−n of the relevance in the search engine site SE_{Y}) of the queries containing the search terms per month) of the search terms Tₘ−n in the search engine site SE_{Y}.

Here, according to the present embodiment, it is preferred that a big keyword (for instance, when it is a website WS_{C} of a job offer introduction, a part-time (side) job (a-ru-ba-i-to in Japanese), a job (ba-i-to in Japanese), a part (pa-a-to in Japanese), etc.) that relates to each of goods and services handled in the website WS_{C} is fully selected, a request in which these big keywords are included as the search terms is transmitted to the keyword advice tool server 82_{Y}, and the search terms of the related term groups in the response that is replied from the keyword advice tool server 82_{Y} and each search volume are accumulated into the database DB2.

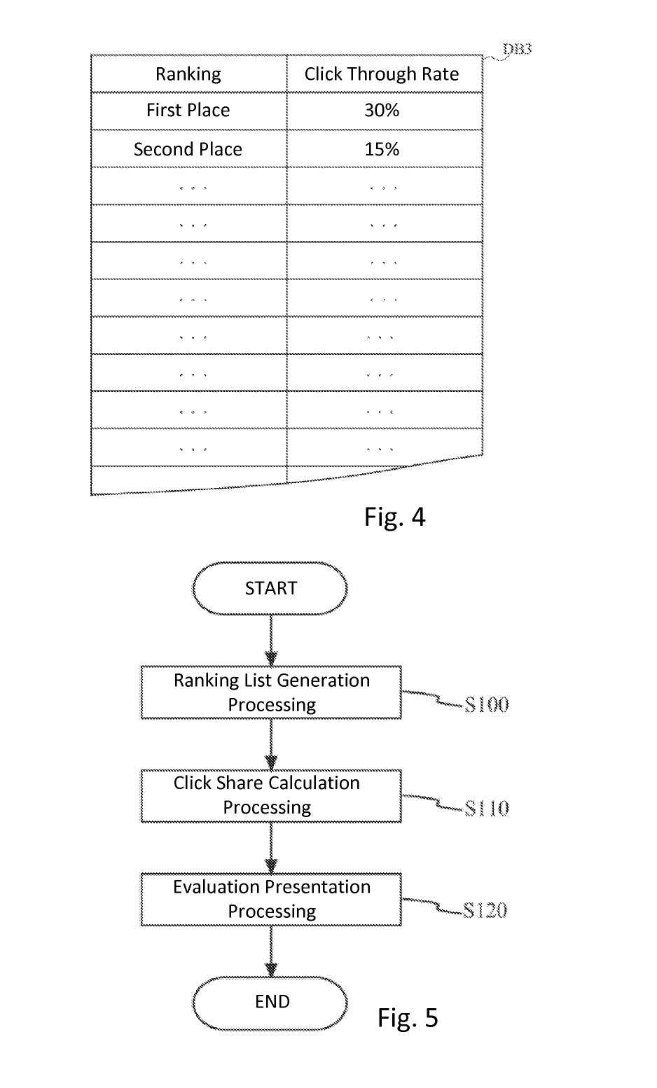

FIG. 4 is a diagram that conceptually shows a data structure of the database DB3. The database DB3 is an aggregate of a plurality of records in which each record corresponds to each ranking i (i=1-L) of the top L (L is an integer greater than or equal to 2, for instance, L=100) rankings in the search result R of the search engine site SE_{Y}. Each record of this database DB3 has two fields of a “ranking” and a “click through rate.” The field of the “ranking” shows the ranking i. The field of the “click through rate” shows an anticipation click through rate CTR−i of the ranking i. In regards to the anticipation click through rate CTR−i (i=1-L) in this database DB3, it is preferred that a value that is disclosed as statistical information from, such as, the managing agency entrepreneur of the search engine site SE_{Y} is used.

Next, an operation of the present embodiment is explained below. FIG. 5 is a flow diagram that shows a process of the investment judgement support server 10. The process shown in FIG. 5 is realized by an evaluation program PR. In FIG. 5, a CPU 12 of the investment judgement support server 10 performs a ranking list generation process (S100).

In the ranking list generation process, the search terms Tₘ (m=1-M)−n(n=1-Nₘ) of the search term groups TGₘ (m=1-M) in the database DB2 are transmitted to the search engine server 81_{Y} as the query, a search result Rₘ−n of the search in which each search term Tₘ−n corresponds to the query from the search engine server 81_{Y} is obtained, a search term group ranking list LSTₙ in which the ranking i of each website WS in the obtained search result Rₘ−n within the same website WS is classified is generated, and the search term group ranking list LSTₙ of each search term group TGₘ that is generated is stored in the hard disk 15.

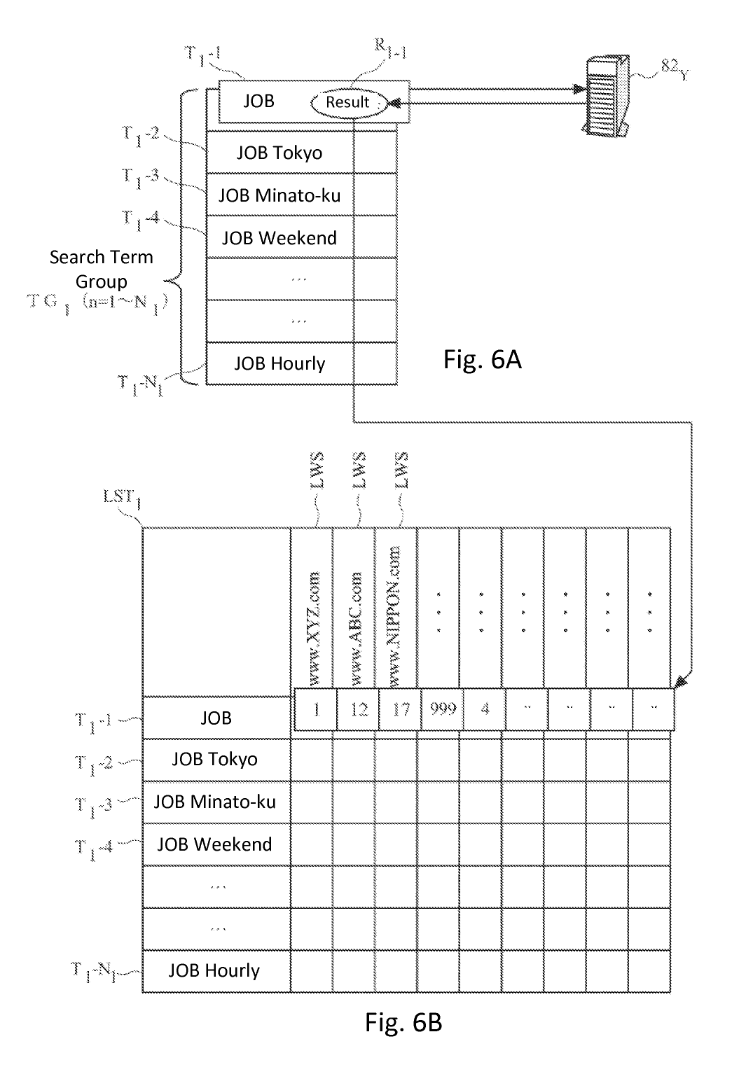

When it is explained in detail, in the ranking list generation process, the CPU 12 selects a table TB₁ out of the table TB, (m=1-M) in the database DB2 and reads out a search term group TG₁ that is stored in this table TB₁ to the RAM 13. As shown in FIG. 6A, the CPU 12 transmits the query containing a search term T₁−n (n=1-N₁) that belongs to the search term group TG₁ in the RAM 13 to the search engine server 81_{Y} and obtains a search result R₁−n (URLs of the websites WS of each ranking i of the top L rankings in the search engine site SE_{Y}) of every search term T₁−n from the search engine server 81_{Y}.

As shown in FIG. 6B, the CPU 12 makes the websites WS that are ranked within the top L rankings (L=100) in one or more search results R₁−n out of the search results R₁−n (n=1-N₁) of the search term T₁−n (n=1-N₁) that belongs to the search term group TG₁ as the websites LWS that is a list item creation object, makes the rankings i (the 999th place when the ranking i is lower than the Lth (L=100) place) of the websites LWS in each of the search results R₁−n (n=1-N₁) classified by every ranking i of the URLs within the same website LWS as a search term group ranking list LST₁ of the search term group TG₁, and stores this search term group ranking list LST₁ in the hard disk 15.

The CPU 12 repeats the same processing explained above for a search term group TG₂, a search term group TG₃, . . . a search term group TG_{M} and stores search term group ranking lists LST₂, LST₃, . . . LST_{M} that are obtained by the repeated processing in the hard disk 15.

In FIG. 5, the CPU 12 performs a click share calculation process (S110). In the click share calculation process, the search term group ranking list LSTₘ of each search term group TGₘ in the hard disk 15 is configured to a ranking reference destination, the ranking i of the website WS_{C} of every search term Tₘ−n in the search term group ranking list LSTₘ as the ranking reference destination is referred, each of multiplication results obtained by multiplying the click through rate CTR−i according to the reference ranking i of every search term Tₘ−n by an individual search volume SVₘ−n of every search term Tₘ−n is summed up, a division result obtained by dividing a sum of each multiplication result of the click through rate CTR−i and the search volume SVₘ−n by a sum of the search volume SVₘ−n of the search term group TGₘ is configured to a click share rate CTSₘ that is unique to the search term group ranking list LSTₘ as the ranking reference destination in the website WS_{C}.

When it is explained in detail, in the click share calculation process, the CPU 12 reads out the URLs of a plurality of websites WS_{C} (for instance, three websites WS_{C}A, WS_{C}B and WS_{C}C), which the company C that is the evaluation object in the database DB1 owns, to the RAM 13.

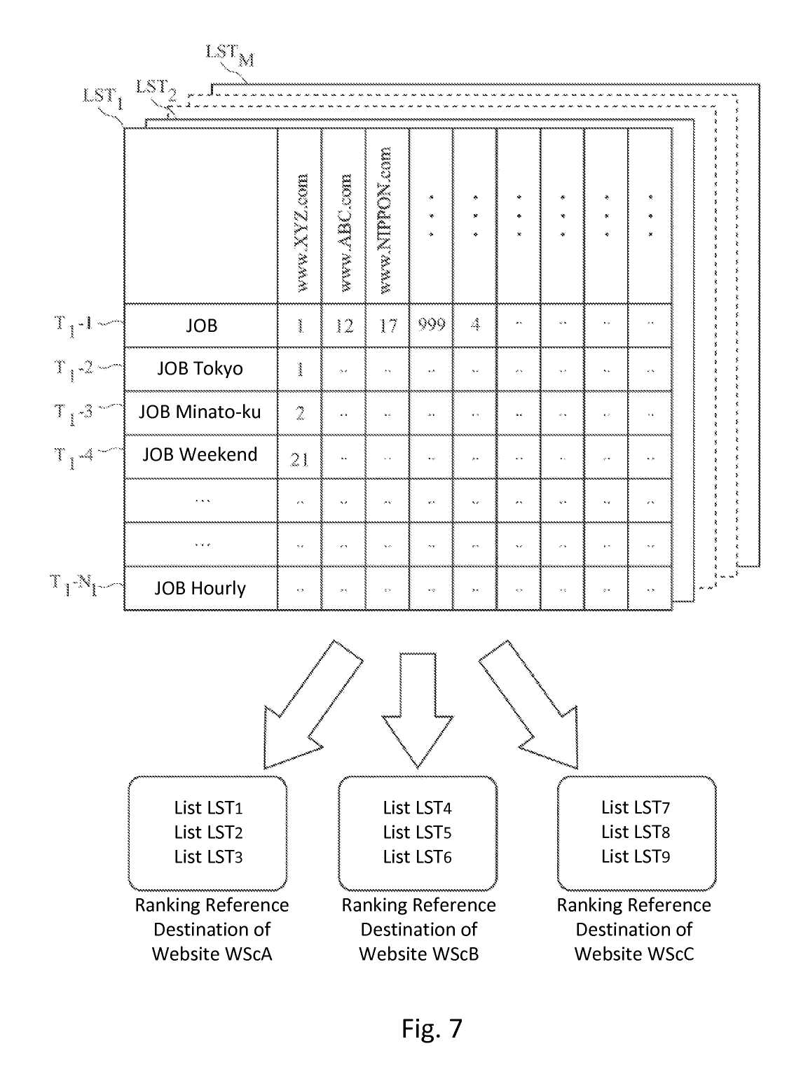

As shown in FIG. 7, the CPU 12 selects the search term group ranking lists LSTₘ (for instance, search term group ranking lists LST₁, LST₂ and LST₃) in which the ranking i of the website WS_{C}A of the company C that is the evaluation object in one or more of the search results Rₘ−n is ranked in an upper ranking than L (L=100) out of the search term group ranking lists LSTₘ (m=1-M) of the search term group TGₘ (m=1-M) and makes these search term group ranking lists LST₁, LST₂ and LST₃ as the ranking reference destinations of the website WS_{C}A.

Further, the CPU 12 selects the search term group ranking lists LSTₘ (for instance, search term group ranking lists LST₄, LST₅ and LST₆) in which the ranking i of the website WS_{C}B of the company C that is the evaluation object in one or more of the search results Rₘ−n of the search terms Tₘ−n is ranked in an upper ranking than L (L=100) out of the search term group ranking lists LSTₘ (m=1-M) of the search term group TGₘ (m=1-M) and makes these search term group ranking lists LST₄, LST₅ and LST₆ as the ranking reference destinations of the website WS_{C}B.

Further, the CPU 12 selects the search term group ranking lists LSTₘ (for instance, search term group ranking lists LST₇, LST₈ and LST₉) in which the ranking i of the website WS_{C}C of the company C that is the evaluation object in one or more of the search results Rₘ−n of the search terms Tₘ−n is ranked in an upper ranking than L (L=100) out of the search term group ranking lists LSTₘ (m=1-M) of the search term group TGₘ (m=1-M) and makes these search term group ranking lists LST₇, LST₈ and LST₉ as the ranking reference destinations of the website WS_{C}C.

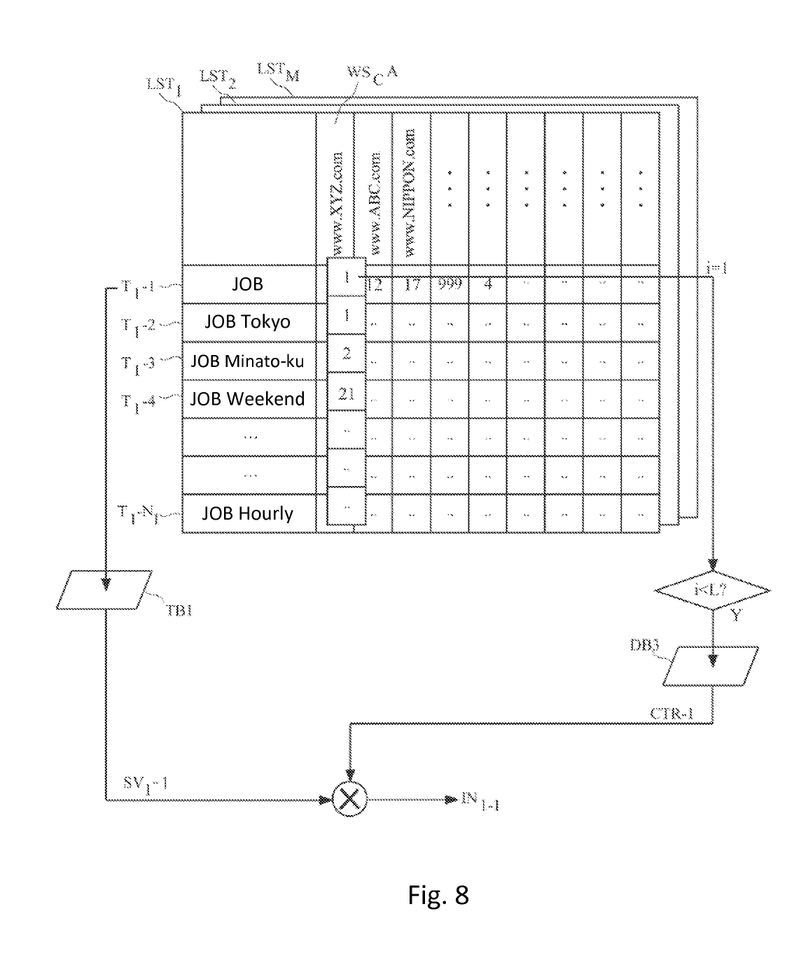

As shown in FIG. 8, the CPU 12 selects one (as an example in FIG. 8, the search term group ranking list LST₁) out of the search term group ranking lists LST₁, LST₂ and LST₃ that correspond to the ranking reference destinations of the website WS_{C}A and judges whether the ranking i (as an example in FIG. 8, i=1st place) of the website WS_{C}A in the search result R₁−1 of a first search term T₁−1 (as an example in FIG. 8, the “job” (ba-i-to in Japanese)) of this search term group ranking list LST₁ is ranked in the upper ranking than L (L=100) or not. Then, when the ranking i is ranked in the upper ranking than L (L=100), the click through rate CTR−i that corresponds to this ranking i in the database DB3 is read out from the database DB3, at the same time, a search volume SV₁−1 that corresponds to the first search term T₁−1 in the table TB₁ of database DB2 is read out, the click through rate CTR−i and the search volume SV₁−1 that are read out are multiplied, and this multiplication result is configured to an anticipation click number IN₁−1 with respect to the website WS_{C}A based on the search result R₁−1 of the first search term T₁−1.

The CPU 12 repeats the same processing explained above in regards to a second search term T₁−2, a third search term T₁−3 . . . a Nth search term T₁−N₁ of the search term group ranking list LST₁ and calculates an anticipation click number IN₁−2 of the website WS_{C}A based on a search result R₁−2 of the second search term T₁−2, an anticipation click number IN₁−3 of the website WS_{C}A based on a search result R₁−3 of the third search term T₁−3, . . . and an anticipation click number IN₁−N₁ of the website WS_{C}A based on a search result R₁−N₁ of the Nth search term T₁−N₁ in the search term group ranking list LST₁.

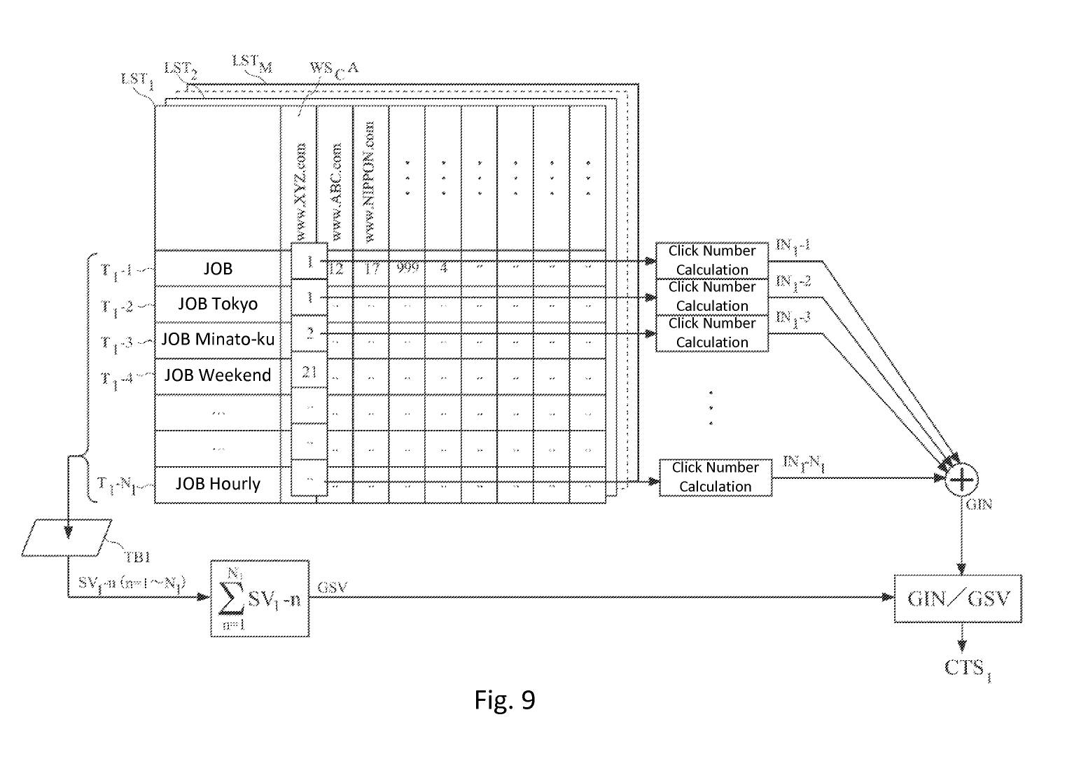

Thereafter, as shown in FIG. 9, a GIN that corresponds to a sum of the anticipation click number IN₁−n (n=1-N₁) of the website WS_{C}A based on the search results R₁−n (n=1-N₁) of the search terms T₁−n (n=1-N₁) in the search term group ranking list LST₁ is divided by a GSV that corresponds to a sum of the search volumes SVₘ−n (n=1-N₁) of all the search terms T₁−n (n=1-N₁) that belong to the search term groups TGₘ, and this divided result GIN/GSV is configured to the click share rate CTS₁ that is unique to the search term group ranking list LST₁ in the website WS_{C}A.

The CPU 12 repeats the same processing explained above in regards to the remaining two search term group ranking lists LST₂ and LST₃ that correspond to the ranking reference destinations of the website WS_{C}A, each of the search term group ranking lists LST₄, LST₅ and LST₆ that correspond to the ranking reference destinations of the website WS_{C}B, each of the search term group ranking lists LST₇, LST₈ and LST₉ that correspond to the ranking reference destinations of the website WS_{C}C, and calculates the click share rate CTS₁ that is unique to the search term group ranking list LST₁ in the website WS_{C}A, a click share rate CTS₂ that is unique to the search term group ranking list LST₂ in the website WS_{C}A, a click share rate CTS₃ that is unique to the search term group ranking list LST₃ in the website WS_{C}A, a click share rate CTS₄ that is unique to the search term group ranking list LST₄ in the website WS_{C}B, a click share rate CTS₅ that is unique to the search term group ranking list LST₅ in the website WS_{C}B, a click share rate CTS₆ that is unique to the search term group ranking list LST₆ in the website WS_{C}B, a click share rate CTS₇ that is unique to the search term group ranking list LST₇ in the website WS_{C}C, a click share rate CTS₈ that is unique to the search term group ranking list LST₈ in website WS_{C}C and a click share rate CTS₉ that is unique to the search term group ranking list LST₉ in the website WS_{C}C.

In FIG. 5, when an operation of instructing a presentation of the latest evaluation result of the company C is performed, the CPU 12 performs an evaluation presentation process (S120). In the evaluation presentation process, a value, which is obtained by weight-adding the click share rates CTSₘ that are calculated every search term group ranking list LSTₘ for each of the URLs of the plurality of websites WS of the company that is the evaluation object owns, is configured to an index value V of an investment judgement for the company C, and a relationship between this index value V and a stock price P of the company C that is the evaluation object is presented.

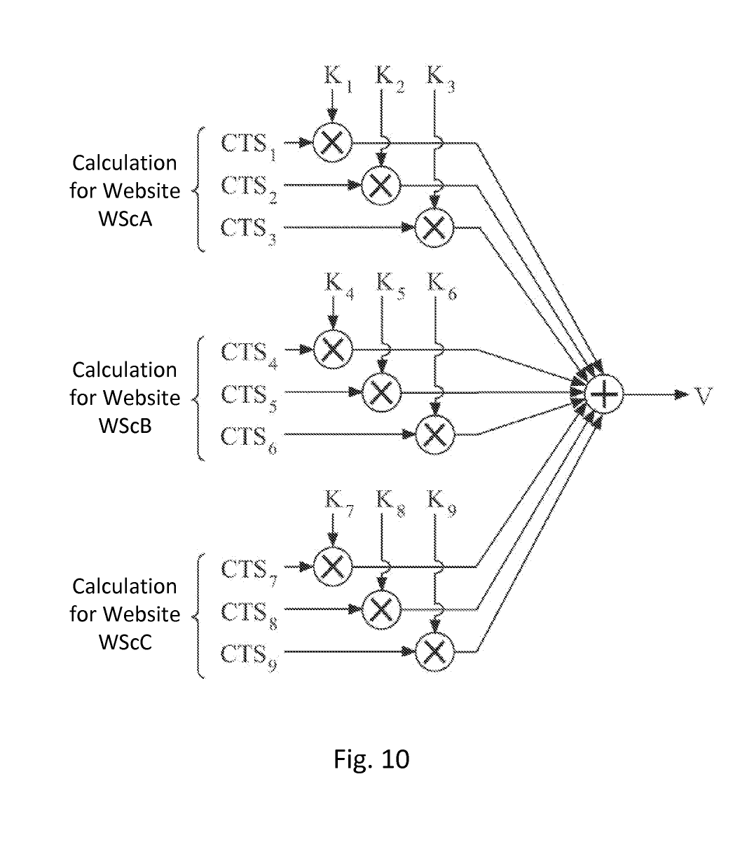

When it is explained in detail, as shown in FIG. 10, in the evaluation presentation process, the CPU 12 respectively multiplies a plurality of click share rates CTSₘ (as an example in FIG. 10, the click share rates CTS₁, CTS₂, CTS₃, CTS₄, CTS₅, CTS₆, CTS₇, CTS₈ and CTS₉) that are generated for every combination of the websites WS_{C} that the company C owns and the search term group ranking lists LSTₘ in the click share calculation process by a coefficient Kₘ (as an example in FIG. 10, coefficients K₁, K₂, K₃, K₄, K₅, K₆, K₇, K₈ and K₉) having a value according to the sum of the search volumes SVₘ−n (n=1-Nₘ) of all the search terms Tₘ−n (n=1-Nₘ) in the search term group ranking lists LSTₘ that are referred to at the time of each calculation. Further, the CPU 12 sums each multiplication result of the click share rates CTSₘ and the coefficients Kₘ, and this sum is configured to the index value V for the investment judgement about the company C.

Next, the CPU 12 inquires the stock price information providing server 83 about the stock price P of the company C and obtains the latest stock price P of the company C from the stock price information providing server 83. The CPU 12 displays a chart CHRP that shows transition of the stock price P of the company C during a predetermined period T_{c} (for instance, T_{C}=six months) before today and a chart CHRV that shows transition of the index value V of the company C during the period T_{c} before today on a display 16 as information that shows a relationship between the stock price P and the index value V. Further, the CPU 12 judges whether a value X (a ratio of the stock price P to the index value V) that is obtained by substituting the latest stock price P and the latest index value V for a following relational expression (1) is less than a threshold value Th or not, and when the value X is less than the threshold value Th, the CPU 12 displays an alert message near the chart CHRV.

X=V/P (1)

The above is the detailed configuration of the present embodiment. According to the present embodiment, the following effects can be obtained. First, according to the present embodiment, in regards to each of the plurality of websites WS_{C} of the company C that is the evaluation object owns, in the investment judgement support server 10, the search term group ranking lists LSTₘ of each search term group TGₘ in the hard disk 15 are configured to the ranking reference destinations, the rankings i of the websites WS_{C} of every search term Tₘ−n in the search term group ranking lists LSTₘ of the ranking reference destinations are referred, each of the multiplication results INₘ−n (the number of anticipation clicks) that are obtained by multiplying the individual search volumes SVₘ−n of every search term Tₘ−n and the click through rates CTR−i according to the referenced rankings i of the every search term Tₘ−n are summed, the divided results that are obtained by dividing the GIN that corresponds to the sum of each of the multiplication results INₘ−n (the number of the anticipation clicks) by the GSV that corresponds to the sum of the individual search volumes SVₘ−n of the every search term Tₘ−n are configured to the click share rate CTSₘ that is unique to the search term group ranking lists LSTₘ of the ranking reference destinations in websites WS_{C}, and the value that is obtained by the weigh-adding the click share rates CTSₘ that are individually calculated about the plurality of websites WS_{C} that the company C owns is configured to the evaluation value V of the company C. The evaluation value V of the company C that is obtained as explained above turns into a value that has a strong positive correlation with a market share of the goods and services in the company C. Therefore, according to the present embodiment, when the company C that is the evaluation object depends heavily on a website in regards to their profits, a user can correctly judge whether the present stock price of the company C is suited to a true competitive strength or not.

Second, according to the present embodiment, the investment judgement support server 10 multiplies the plurality of click share rates CTSₘ that are generated for every combination of the websites WS_{C} that the company C owns and the search term group ranking lists LSTₘ in the click share calculation process by the coefficients Kₘ of the value according to the sum of the search volumes SVₘ−n (n=1-Nₘ) of all the search terms Tₘ−n (n=1-Nₘ) in the search term group ranking lists LSTₘ at the time of each calculation, and the sum of each of the multiplication results of the click share rates CTSₘ and the coefficients Kₘ is configured to the index value V. Therefore, according to the present embodiment, earning power of each company C can be objectively evaluated.

Third, according to the present embodiment, the investment judgement support server 10 obtains the latest stock price P of the company C that is the evaluation object from the stock price information providing server 83, and when a V/P that is the ratio of the index value V to the stock price P of the company C that is the evaluation object is less than the threshold value Th, the investment judgement support server 10 displays the alert message on the screen of the display 16. Therefore, according to the present embodiment, the user can know that the evaluation of the company C in the stock market became excessive as compared with the true competitive strength before it appears in the stock price P.

### Second Embodiment

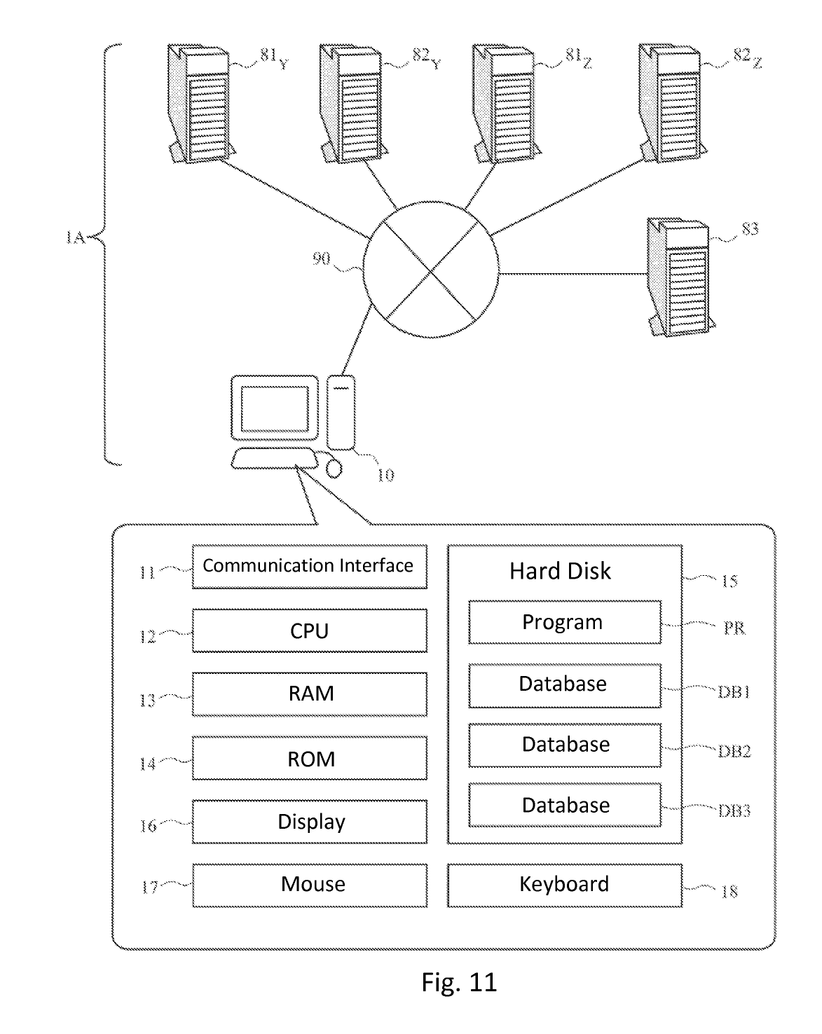

FIG. 11 is a diagram that shows an entire configuration of an investment judgement support system 1A according to a second embodiment of the present invention. This system 1A has a search engine server 81_{Z} and a keyword advice tool server 82_{Z} that work under management of a managing agency entrepreneur of a search engine site SE_{Z} that is different from the search engine site SE_{Y}.

The search engine server 81_{Z} receives a query (a request containing a search term) in which an address corresponds to a URL of the search engine site SE_{Z} from a computer connected to the Internet 90, searches related websites that have high relevance with the search term contained in the query out of the websites WS in the Internet 90, and provides a search result R in which a set of titles of the searched websites WS, URLs and snippets are arranged in ascending order.

The keyword advice tool server 82_{Z} receives a request containing a search term from a computer connected to the Internet 90 and provides a response containing a related term group of the search term in the request and a search volume of each search term of the related term group in the search engine site SE_{Z}.

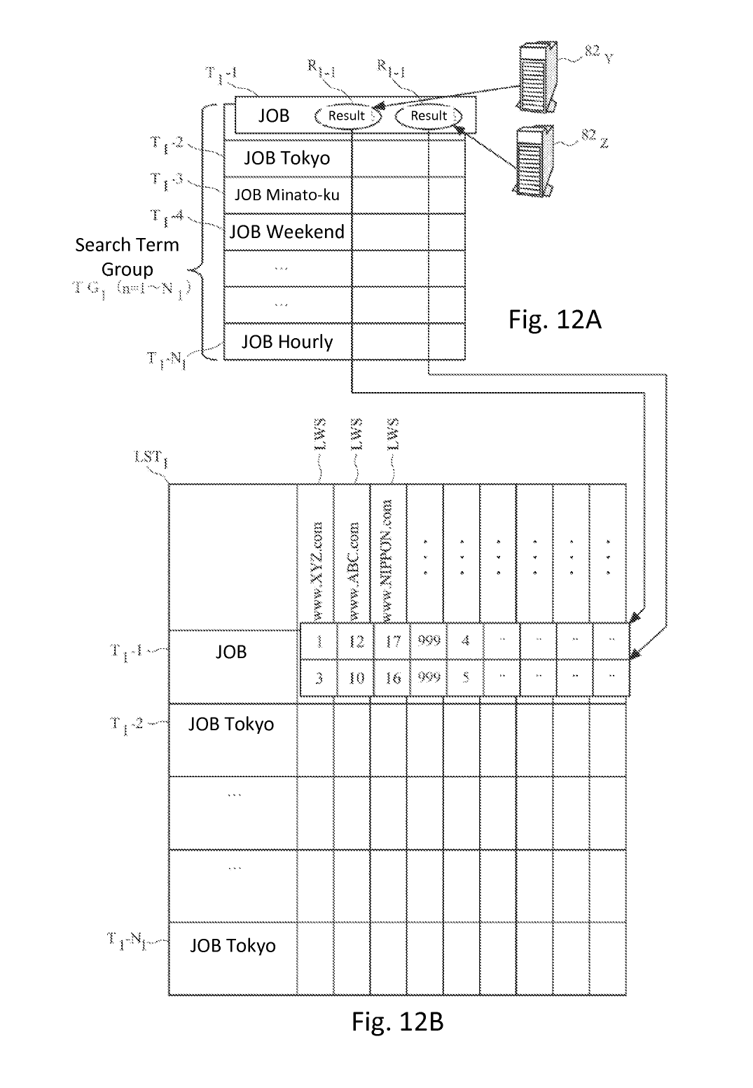

According to the present embodiment, the investment judgement support server 10 evaluates the competitive strength of a company C in the search results of a plurality of search engine site SE_{Y} and search engine site SE_{Z}. When it is explained in detail, as shown in FIGS. 12A-12B, the CPU 12 of the investment judgement support server 10 obtains the search results Rₘ−n in which the search terms Tₘ−n in the search engine site SE_{Y} are the queries from the search engine server 81_{Y}, obtains the search results Rₘ−n in which the search terms Tₘ−n in search engine site SE_{Z} are the queries from the search engine server 81_{Z}, and makes a list in which the rankings i of each of the websites WS_{C} in these search results are classified within the same website WS_{C} as the search term group ranking list LSTₘ. Further, the CPU 12 of the investment judgement support server 10 calculates an anticipation click number INₘ−n for every search term T₁−n of the search term groups TGₘ based on the search results Rₘ−n of the search engine SE_{Y} in the search term group ranking lists LSTₘ, and calculates an anticipation click number INₘ−n for every search term Tₘ−n of the search term groups TGₘ based on the search results Rₘ−n of the search engine SE_{Z} in the search term group ranking lists LSTₘ. Thereafter, a GIN′ that corresponds to a sum of a sum of the anticipation click numbers INₘ−n (n=1-Nₘ) calculated with respect to the search engine SE_{Y} and a sum of the anticipation click numbers INₘ−n (n=1-Nₘ) calculated with respect to the search engine SE_{Z} is obtained. Further, a GSV′ that corresponds to a sum of a sum of the search volumes SVₘ−n (n=1-Nₘ) of the search term groups TGₘ in the search engine SE_{Y} and a sum of the search volumes SVₘ−n (n=1-Nₘ) of the search term groups TGₘ in the search engine SE_{Z} is obtained, and a GIN′/GSV′ is configured to a click share rate CTSₘ.

According to the present embodiment, the click share rate CTSₘ is calculated by using the search results of the plurality of search engine sites, the search engine site SE_{Y} and the search engine site SE_{Z}. Therefore, the evaluation with high objectivity related to the company C can be performed.

### Other Embodiments

Although the first and second embodiments according to the present invention are explained above, the following variations may be added.

(1) In the click share calculation process according to the first and second embodiments explained above, the CPU 12 respectively multiplies the sum of the click share rates CTSₘ of each of the websites WS by the weight-added coefficients Kₘ having the values according to the sum of the search volumes SVₘ−n of each of the search terms Tₘ−n of the search term groups TGₘ (m=1-M) and makes the value corresponding to the sum of addition results that are obtained by multiplying the click share rates CTSₘ and the weight-added coefficients K as the index value V. However, a value obtained by directly adding the click share rates CTSₘ of each of the websites WS can be configured to the evaluation value V.

(2) According to the first and second embodiments explained above, the present invention is applied to the evaluation of the company C that has two or more kinds of the websites WS_{C}. However, the present invention can also be applied to the evaluation of one website WS_{C}. According to this embodiment, the click share calculation process explained above is performed to this website WS_{C} that is an evaluation object, and a click share rate CTSₘ of the website WS_{C} that is obtained by this processing is presented as an evaluation value of the website WS_{C}. According to this embodiment, a user can accurately estimate with respect to the profits of the company C that depends heavily on service in the website WS_{C} in regards to the sales.

(3) In the evaluation presentation process according to the first and second embodiments explained above, when the value X that is obtained by substituting the latest stock price P and the latest index value V for the relational expression (1) that is shown above is less than the threshold value Th, the CPU 12 displays the alert message. However, this relational expression does not need to show the ratio of the stock price P to the index value V. For instance, a formula for computing a difference between the stock price P and the index value V is prepared, and an alert message can also be displayed when the difference obtained by this formula exceeds the threshold value Th.

(4) In the evaluation presentation process according to the first and second embodiments explained above, the CPU 12 shows the relationship between the latest stock price P and the latest index value V. However, a relationship between a latest financial index value and the latest index value V can also be presented by obtaining the financial index value, such as a market capitalization, a price-earnings ratio (PER) and a price book-value ratio, of the company C that is the evaluation object instead of the stock price P.

(5) According to the first and second embodiments explained above, when the managing agency entrepreneur of the investment judgement support server 10 is the same as the managing agency entrepreneur of the search engine site SE_{Y} (or SE_{Z}), or the managing agency entrepreneur of the investment judgement support server 10 can obtains actual click number information that corresponds to an actual click number Numₘ (m=1-M)−n(n=1-Nₘ) (more specifically, the number accessed to the website WSc based on the search results in which each of the search terms Tₘ (m=1-M)−n(n=1-Nₘ) belonging to the search term groups TGₘ (m=1-M) are configured to the queries) of the website WS of the company C in the search results of the search terms Tₘ (m=1-M)−n(n=1-Nₘ) of the search term groups TGₘ (m=1-M), the investment judgement support server 10 can also calculate the click share rates CTSₘ based on this actual click number information without generating the search term group ranking lists LSTₘ. In this embodiment, in regards to the search term groups TGₘ that the hypothetical customer of the website WSc that the company C owns will use as the query for the search engine site SE_{Y} (or SE_{Z}), the investment judgement support server 10 sums click numbers Numₘ−n (n=1-Nₘ) of the website WSc in the search results of the search engine site SE_{Y} (or SE_{Z}) for the search terms Tₘ−n belonging to the search term group TGₘ, makes a divided result that is obtained by dividing the sum of the search volumes SVₘ−n (n=1-Nₘ) of the search term groups TGₘ by the sum of the click numbers Numₘ−n (n=1-Nₘ) of the search term groups TGₘ as a click share rate CTSₘ, and presents this click share rate CTSₘ as an index value of the evaluation of the website WSc.

### EXPLANATION OF REFERENCE NUMERALS

1—Investment judgement support system,
10—Investment judgement support server,
11—Communication interface,
12—CPU,
13—RAM,
14—ROM,
15—Hard disk
15, 16—Display,
17—Mouse,
18—Keyboard,
81—Search engine server,
82—Keyword advice tool server,
83—Stock price information providing server.

The evaluation method, the evaluation device and the program being thus described, it will be apparent that the same may be varied in many ways. Such variations are not to be regarded as a departure from the spirit and scope of the invention, and all such modifications as would be apparent to one of ordinary skill in the art are intended to be included within the scope of the following claims.

1. An evaluation method of a corporate value by a computer that causes a processor to execute a process, the computer having a memory device that stores a first database containing URLs of a plurality of websites which an evaluated company holds and a second database containing a plurality of search term groups which a hypothetical customer of the plurality of websites uses as a query for a search engine site, the evaluation method comprising executing on the processor the steps of:
generating a ranking list including:
transmitting each search term of the plurality of search term groups to the search engine site as the query with respect to each of the plurality of search term groups in the second database;
obtaining a search result for each of the search terms as the query from the search engine site;
generating a search term group ranking list in which a website ranking of each of the search terms within the same website of the plurality of websites is classified; and
storing the search term group ranking list of each of the plurality of search term groups in the memory device;
calculating a click share including:
referring the website ranking of a corresponding website for each of the search terms in the search term group ranking list, which is for each of the plurality of search term groups in the memory device, as a ranking reference destination with respect to each of the URLs of the plurality of websites in the first database;
summing a multiplication result obtained by multiplying a click through rate, which corresponds to the referred ranking of each of the search terms, by a search volume of each of the search terms; and
obtaining a click share rate that is a division result of dividing a sum of the multiplication result by a sum of the search volume of each of the plurality of search term groups, the click share rate being unique to the search term group ranking list as the ranking reference destination in the corresponding website; and
presenting an evaluation result including:
generating an index value for an investment judgement, the index value being obtained by adding or weight-adding the click share rate, which is calculated for the search term group ranking list with respect to each of the URLs of the plurality of websites in the first database; and
presenting a relationship between the index value and one of a stock price and a financial index value of the evaluated company.

2. The evaluation method according to claim 1, wherein the presenting the evaluation result includes:
generating a plurality of click share rates for each combination of the search term group ranking list and a website of each of the URLs of the plurality of websites;
multiplying the plurality of click share rates by a weighting coefficient corresponding to the sum of the search volume of each of the search terms in the search term group ranking list that is referred at each calculation; and
the index value is a sum of a multiplication result between the click share rate and the weighting coefficient.

3. The evaluation method according to claim 2, wherein the presenting the evaluation result includes:
obtaining the stock price of the evaluated company from a stock price information providing server by inquiring the stock price of the evaluated company to the stock price information providing server; and
outputting from an alert message when a value obtained by a predetermined expression in which the stock price and the index value are substituted is more than or less than a threshold value.

4. An evaluation device that is configured to execute processes by a processor, the evaluation device comprising:
a memory device that stores a first database containing URLs of a plurality of websites which an evaluated company holds and a second database containing a plurality of search term groups which a hypothetical customer of the plurality of websites uses as a query for a search engine site;
the processor configured to provide:
a ranking list generator that is configured to transmit each search term of the plurality of search term groups to the search engine site as the query with respect to each of the plurality of search term groups in the second database, that is configured to obtain a search result for each of the search terms as the query from the search engine site, that is configured to generate a search term group ranking list in which a website ranking of each of the search terms within the same website of the plurality of websites is classified, and that is configured to store the search term group ranking list of each of the plurality of search term groups in the memory device;
a click share calculator that is configured to refer the website ranking of a corresponding website for each of the search terms in the search term group ranking list, which is for each of the plurality of search term groups in the memory device, as a ranking reference destination with respect to each of the URLs of the plurality of websites in the first database, that is configured to sum up a multiplication result obtained by multiplying a click through rate, which corresponds to the referred ranking of each of the search terms, by a search volume of each of the search terms, and that is configured to obtain a click share rate that is a division result of dividing a sum of the multiplication result by a sum of the search volume of each of the plurality of search term groups, the click share rate being unique to the search term group ranking list as the ranking reference destination in the corresponding website; and
an evaluation result presentation device that is configured to generate an index value for an investment judgement, the index value being obtained by adding or weight-adding the click share rate, which is calculated for the search term group ranking list with respect to each of the URLs of the plurality of websites in the first database and that is configured to present a relationship between the index value and one of a stock price and a financial index value of the evaluated company.

5. A non-transitory computer-readable medium for causing a computer to execute processes, comprising instructions thereon, that when executed on a processor, perform the steps of:
storing a first database containing URLs of a plurality of websites which an evaluated company holds and a second database containing a plurality of search term groups which a hypothetical customer of the plurality of websites uses as a query for a search engine site in a memory device;
generating a ranking list including:
transmitting each search term of the plurality of search term groups to the search engine site as the query with respect to each of the plurality of search term groups in the second database;
obtaining a search result for each of the search terms as the query from the search engine site;
generating a search term group ranking list in which a website ranking of each of the search terms within the same website of the plurality of websites is classified; and
storing the search term group ranking list of each of the plurality of search term groups in the memory device;
calculating a click share including:
referring the website ranking of a corresponding website for each of the search terms in the search term group ranking list, which is for each of the plurality of search term groups in the memory device, as a ranking reference destination with respect to each of the URLs of the plurality of websites in the first database;
summing a multiplication result obtained by multiplying a click through rate, which corresponds to the referred ranking of each of the search terms, by a search volume of each of the search terms; and
obtaining a click share rate that is a division result of dividing a sum of the multiplication result by a sum of the search volume of each of the plurality of search term groups, the click share rate being unique to the search term group ranking list as the ranking reference destination in the corresponding website; and
presenting an evaluation result including:
generating an index value for an investment judgement, the index value being obtained by adding or weight-adding the click share rate, which is calculated for the search term group ranking list with respect to each of the URLs of the plurality of websites in the first database; and
presenting a relationship between the index value and one of a stock price and a financial index value of the company.

6. An evaluation method for causing a processor to execute a process, the method comprising executing on the processor the steps of:
summing a number of clicks at a website in a search result of a search engine site with respect to each search term belonging to search term groups which a hypothetical customer of the website uses as a query for the search engine site;
obtaining a click share rate that is a division result of dividing a sum of the number of clicks of the search term groups by a sum of a search volume of the search term groups; and
presenting the click share rate as an evaluation index value for the website.

7. An evaluation method of a corporate value by a computer for causing a processor to execute a process, the computer having a memory device that stores a first database containing URLs of a plurality of websites and a second database containing a plurality of search term groups which a hypothetical customer of the plurality of websites uses as a query for a search engine site, the evaluation method comprising executing on the processor the steps of:
generating a ranking list including:
transmitting each search term of the plurality of search term groups to the search engine site as the query with respect to each of the plurality of search term groups in the second database;
obtaining a search result for each of the search terms as the query from the search engine site;
generating a search term group ranking list in which a website ranking of each of the search terms within the same website of the plurality of websites is classified; and
storing the generated search term group ranking list in the memory device; and
presenting an evaluation result including:
referring the website ranking of a corresponding website for each of the search terms in the search term group ranking list, which is for each of the plurality of search term groups in the memory device, as a ranking reference destination with respect to each of the URLs of the plurality of websites in the first database;
summing a multiplication result obtained by multiplying a click through rate, which corresponds to the referred ranking of each of the search terms, by a search volume of each of the search terms;
obtaining a click share rate that is a division result of dividing a sum of the multiplication result by a sum of the search volume of each of the plurality of search term groups, the click share rate being unique to the search term group ranking list as the ranking reference destination in the corresponding website; and
presenting the click share rate as an evaluation index value for the corresponding website.
